(19) United States
(12) Patent Application Publication
(10) Pub. No.: US 2004/0116156 A1
(43) Pub. Date: Jun. 17, 2004

(54) Coding of trau frames in a cellular radio telecommunication system

(76) Inventors: Neil Philip Piercy, London (GB); Nicholas Dougall Johnson, London (GB)

Correspondence Address: Gregory J Lavorgna, Drinker Biddle & Reath, One Logan Square, 18th and Cherry Streets, Philadelphia, PA, 19103, US

(21) Appl. No.: 10/475,277

(22) PCT Filed: Mar. 15, 2002
(86) PCT No.: PCT/GB02/01251

(30) Foreign Application Priority Data
Apr. 18, 2001 (GB) 0109531.4

(51) Int. Cl. H04Q 7/20; H04B 1/38

(52) U.S. Cl. 455/560; 455/436

(57) ABSTRACT

A cellular radio telecommunication system comprising a BaseStation Transceiver System BTS and Transcoder Rate Adaptor TRAU in which the TRAU implements pre-coding of Enhanced Full-Rate EFR speech data for error checking at the Mobile Station MS. The BTS and TRAU may be co-located, or separated by a transmission link which has very low error rates. Error detection bits in the TRAU frame carrying Enhanced Full Rate EFR speech data may conform to a predetermined pattern which is recognised by the BTS and ignored for error correction. These error detection bits may be used across the BTS-TRAU interface for error checking of all the speech data bits of the TRAU frame evenly. The TRAU and BTS may negotiate the error checking protocol to be used so that this conforms to that used by the BTS.

This invention relates to the GSM cellular radio telecommunication systems, especially GSM systems, and methods of error checking speech data in such systems.

The GSM specifications describe an interface between the Basestation Transceiver System (BTS) and the Transcoder Rate Adaptor Unit (TRAU) over which various types of traffic flows, carried in so-called TRAU frames. These TRAU frames typically carry 260 bits of user information in a 320-bit frame (the remaining 60 bits providing frame synchronization, time-alignment and frame type information). There are many configurations of the GSM network, some of which have the TRAU co-located with the BTS, but others of which have the TRAU located at the Basestation Controller (BSC) or Mobile Switching Centre (MSC) remote from the BTS.

One type of user data carried across the BTS-TRAU interface is the Enhanced Full-Rate (EFR) speech data, which comprises 244 bits of compressed speech information. This service is carried in a TRAU frame which has the standard 260 bit carrying capability. The 16 additional bits which these TRAU frames provide have been specified to carry a set of 5 3-bit CRC values, together with 1 spare bit (coded as a constant 1). The 3 bit CRC values are calculated over some of the bits in the 5 distinct subsets of coded data produced by the EFR codec, and serve to validate that the data in these bits has not been corrupted whilst in transit between the BTS and the TRAU. The bits within each subset are selected to be subjectively the most important bits in each subset, and are not contiguous within each subset. The software or hardware processing required to produce these CRC bits for transmission, or to check them on receipt is significant in some BTSs, which otherwise do no processing of the user's speech data.

It should be noted that the EFR speech data is also carried across the radio interface between the BTS and the Mobile Station (MS) by so-called pre-coding of the 244 bits with the addition of a single 8-bit CRC and of 8 additional so-called repetition bits. The CRC is calculated over the 65 most important bits of the 244 bits, and the 8 repetition bits are pairs of repeats of the 4 next most significant bits. This coding provides some error detection capability on the radio interface, which is often subject to errors due to the nature of the radio link.

In some deployments however the probability of errors being introduced between the BTS and the TRAU is very low, especially when they are co-located.

It is an object of the present invention to define alternative uses for the additional 16 bits which may be carried in the EFR TRAU frames which are computationally simpler, and are chosen to provide an appropriate level of additional error checking capability for some deployment scenarios. This invention must be embodied within both the BTS and the TRAU so that they behave in a coordinated manner. It is noted that although the GSM standards define the use of the additional bits as described above, the interface between the TRAU and the BTS is not a standard, testable interface, so other definitions of their use, such as those described herein, are acceptable provided both the TRAU and the BTS conform to them.

According to a first aspect, the invention consists in a cellular radio telecommunication system comprising a BTS and TRAU in which the TRAU implements pre-coding of the EFR speech data for error checking at the MS.

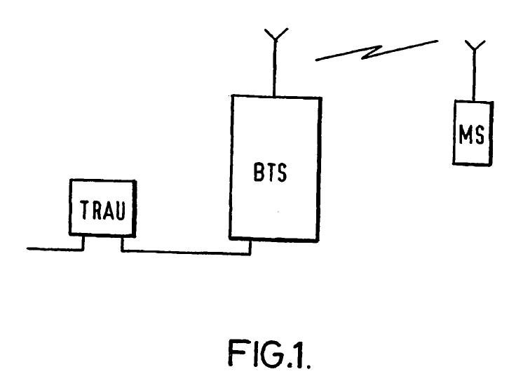

The invention, as illustrated in FIG. 1, is applicable to systems which may be subject to a low, but still noticeable error rate on the interface between the TRAU and BTS, but in which the BTS processing does not have the capability to carry out the standard processing. In this case, the additional bits may be carried transparently through the BTS as they are carried over the air interface by the standard channel codecs between the BTS and the MS. This removes the need for the BTS to process these EFR speech data frames in any way between the main radio interface channel codec and the TRAU interface, and requires the TRAU to implement the normal channel codec pre-coding 8 bit CRC and 8 repetition bits rather than the standard TRAU 5 sets of 3-bit CRCs plus 1 spare bit. This is not a significant difference in processing power requirements for the TRAU, but simplifies the BTS. The level of error protection provided by this scheme is similar to that provided by the standard TRAU interface, although not identical: it is better for some type of errors, but worse for others.

According to a second aspect, the invention consists in a cellular radio telecommunications system comprising a BTS and TRAU in which error detection in the EFR TRAU frame are used across the TRAU interface for error checking of all the speech data bits of the TRAU frame evenly.

Typically, 16 additional bits are used across the TRAU interface so as to provide error detection capability, but this requires considerably reduced processing power requirements in the BTS and the TRAU compared with the standard TRAU 5 sets of 3 bit CRCS plus 1 spare bit. The 16 bits are calculated as an error detection value across all the 244 speech data bits evenly, with no preference given to the most important bits within the 244 bits. This weakens the protection provided against bit errors across this interface, but is acceptable in some deployment scenarios, for example when the BTS and TRAU are co-located, or are separated by a transmission link which has very low error rates. There is a wide choice of calculation used in producing the 16 bits of error detection, all of which are well-known in the field but not applied to this problem, for example (in order of decreasing complexity and also decreasing error detection capability):

16 bit CRC

16 bit arithmetic sum of the 244 bits taken 8 bits at a time

16 bit logical exclusive OR (XOR) of the 244 bits taken 16 bits at a time

combination of 2 of the above schemes applied to only 8 bit results (e.g. 8 bit arithmetic sum and 8 bit XOR of the 244 bits of data taken 8 bits at a time)

In the above descriptions, since 244 is not exactly divisible by 8 (or 16), the operations described as taking 8 or 16 bits at a time may treat the 244 bits as being extended with 4 or 12 zero bits as required to carry out the operation described.

According to a third aspect, the invention consists in a cellular radio telecommunication system comprising a BTS and TRAU in which error detection bits in the EFR TRAU frame conform to a predetermined pattern which is recognised by the BTS and ignored for error correction.

Typically, the BTS sets 16 error detection bits to a fixed, known, pattern on transmission. The TRAU recognises the fixed pattern on reception, and ignores the CRC result for frames containing that pattern. The TRAU performs its normal processing on the downlink, and the BTS ignores the CRC and accepts the TRAU frame unchecked.

This requires considerably reduced processing power requirements in the BTS and the TRAU compared with the standard TRAU 5 sets of 3 bit CRCs plus 1 spare bit, and may be easily implemented in an otherwise standard TRAU to allow its operation with a BTS which does not include the standard CRC processing.

The use of such a simple technique allows its incorporation into an existing TRAU to which both standard BTSs and BTSs using TRAU interfaces according to this aspect of the invention may be attached without the need for special negotiation signalling between BTS and TRAU, whilst minimising the modifications required within existing TRAU equipment This benefit is especially apparent in mixed deployments of BTSs on a single TRAU, where some BTSs have full CRC checking and generation, and other types operate according to the invention.

This does not protect the EFR speech bits from random bit errors (although large bursts of errors of total frame erasure would still be detectable), but is suitable for some deployment scenarios, for example, when the BTS and TRAU are colocated, or are separated by a transmission link which has acceptably low error rates, especially where the error characteristics on the link are such that single random bit errors are rare, and more commonly bursts of several errors typically occur over a short duration, as is often found on transmission links, or local area networks.

In deployments in which there are BTSs both with and without this invention, all connecting to the same TRAU set, the TRAU and BTS may carry out a negotiation of the method to be used for error detection. With only a small and temporary loss of error detection capability, the TRAU tries multiple methods (including the standard GSM method) of error detection on the first few TRAU frames of the connection, and once it has determined the method in use by the BTS, uses that method for the frames sent to the BTS. The BTS may similarly expect such negotiation to be performed by the TRAU at the start of each new connection, and wait for the reception of the first TRAU frames with the 16 additional bits set to the correct error detection scheme before regarding them as providing valid error detection capability for the speech data. The use of the third aspect of the invention with a fixed value for the spare bits also allows the negotiation scheme to be simplified to be stateless, with only a small loss in detection capability, each arriving TRAU frame has the 16 bits checked against the fixed pattern, and only if that fails are they checked against the computationally more expensive standard GSM scheme. For a 16 bit error detection pattern, there is a 1 in 65536 chance that a correct CRC will generate the fixed pattern and allow the TRAU to accept a speech frame unchecked.

The typical embodiment of the invention according to the first aspect above is for the BTS to have the channel codec pre-coder calculations removed from its hardware or software processing fictions, and for them to be added to the TRAU, which is typically implemented in software, often in a specialist Digital Signal Processor (DSP).

The typical embodiment of the invention according to the second or third aspects is for the required calculation to set the spare 16 bits being incorporated into the BTS and TRAU hardware or software processing functions which already exist, such as the BTS main processor, or in the TRAU, in the speech codec typically implemented in a DSP.

1. A cellular radio telecommunication system comprising a Basestation Transceiver System BTS and Transcoder Rate Adaptor TRAU in which the TRAU implements pre-coding of Enhanced Full-Rate EFR speech data for error checking at the Mobile Station MS.

2. A cellular radio telecommunication system comprising a Basestation Transceiver System BTS and Transcoder Rate Adaptor TRAU in which error detection bits in the TRAU frame carrying enhanced full rate EFR speech data are used across the BTS-TRAU interface for error checking of all the speech data bits of the TRAU frame evenly.

3. A system as claimed in claim 2 in which the Basestation Transceiver System BTS and Transcoder Rate Adaptor TRAU are co-located, or are separated by a transmission link which has very low error rates.

4. A cellular radio telecommunication system comprising a Basestation Transceiver System BTS and Transcoder Rate Adaptor TRAU in which error detection bits in the TRAU frame carrying Enhanced Full Rate EFR speech data conform to a predetermined pattern which is recognised by the BTS and ignored for error correction.

5. A system as claimed, in any one of claims 2 to 4 in which the TRAU and BTS negotiate the error checking protocol to be used so that this conforms to that used by the BTS.
